(19) United States
(12) Patent Application Publication
(10) Pub. No.: US 2011/0078724 A1
(43) Pub. Date: Mar. 31, 2011

(54) TRANSACTIONAL ADVERTISING FOR TELEVISION

(75) Inventors: Japan A. MEHTA, Coppell, TX (US); Shafiq Kassam, Lewisville, TX (US); Enrique Ruiz-Velasco, Flower Mound, TX (US); Mousumi Desgupta, Irving, TX (US)

(73) Assignee: VERIZON PATENT AND LICENSING, INC., Basking Ridge, NJ (US)

(21) Appl. No.: 12/571,197

(22) Filed: Sep. 30, 2009

(51) Int. Cl. H04N 7/10; H04N 7/173

(52) U.S. Cl. 725/32; 725/109

(57) ABSTRACT

A method is performed by one or more devices within a closed distribution network to provide transactional advertisements. The method includes sending, over the closed distribution network, an advertisement for presentation by a video client, where the advertisement includes a transactional link; and receiving, over the closed distribution network, a notification from the video client that a user has selected the transactional link. The method also includes automatically establishing, based on the notification, a communication session between the video client and a server associated with the advertisement, where the communication session enables a transactional exchange between the user of the video client and the server associated with the advertisement.

### BACKGROUND INFORMATION

Transactional advertisements provide potential customers with the opportunity to initiate a transaction via the advertisement. Transactional advertisements are typically associated with computers using the Internet, such as when a Web page includes an advertising image with a link that can be selected by a user. Selecting the link may open a new web page that allows the potential customer to make a purchase directly.

Television service providers generate revenue from advertising. However, the nature of most television advertising typically precludes advertisers from associating a transaction with the advertisement. For example, a typical television commercial may encourage a viewer to purchase a product, but the viewer's eventual purchase of the product will occur in a forum not directly associated with the television commercial (e.g., an in-store purchase, a telephone transaction, a Web site transaction, etc.).

### BRIEF DESCRIPTION OF THE DRAWINGS

FIG. 1 depicts an exemplary network in which systems and/or methods described herein may be implemented;

FIG. 2 is a block diagram of exemplary components of a video client that may be used in the network of FIG. 1;

FIG. 3 is a block diagram of exemplary components of a device that may correspond to a backend server and/or a third-party transaction server of FIG. 1;

FIG. 4 depicts a diagram of exemplary functional components of the backend server illustrated in FIG. 1;

FIG. 5 illustrates a diagram of an exemplary on-screen display format including a transactional advertisement according to an implementation described herein;

FIG. 6 illustrates a diagram of an exemplary on-screen display format including a transaction screen according to an implementation described herein;

FIG. 7 is a flow chart illustrating an exemplary process for offering transactional advertising in a closed distribution network;

FIG. 8 is a flow chart illustrating an another exemplary process for offering transactional advertising in a closed distribution network; and

FIGS. 9A and 9B are exemplary diagrams illustrating implementations of a customer interface for transactional advertisements in a closed distribution network.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may permit a subscription multimedia service provider to provide transactional advertisements for television viewers over a closed distribution network. Advertising space may be included within an interactive television application supplied to a video client (e.g., a set-top box) and presented on a display (e.g., a television). A transactional advertisement may be presented within the advertising space, such that the transactional advertisement may be selected by a user of the interactive television application using, for example, a remote control. The video client may provide a notification of the user's selection to a backend server for the subscription multimedia service provider. To facilitate a transaction, the backend server may establish a communication session between the video client and a third-party server associated with the advertisement. A user may then conduct a transaction with the third-party server using an application interface that accommodates user input to the video client via the remote control/display.

As used herein, the term “interactive television application” may refer to an application that may receive and respond to user input (e.g., via a remote control or control buttons on a video client device). For example, an interactive television application may include variations of known social networking applications (e.g., Facebook®, Twitter®, MySpace®, etc.), image- and/or video-sharing applications (e.g., YouTube®, blip®, Veoh®, etc.), applications from premium content providers, regional content applications (e.g., weather, traffic, local news), games, etc. In some cases, interactive television applications may also be referred to as “widgets.”

The term “transactional advertisement,” as used herein, may refer to an advertisement that may be selected by a user to automatically initiate a transaction process related to the advertisement. For example, a transactional advertisement may include a hyperlink or icon that may be selected by a user to initiate a communication session with a remote server.

Also, as used herein, the term “video client” may refer to any media processing device that may receive multimedia content over a network, and may provide such multimedia content to an attached video display device (such as a television or computer monitor). A “subscription multimedia service,” as used herein, may refer to television, telephone, networking and/or other multimedia services provided to customers over a closed distribution network, such as cable, optical fiber, satellite, or virtual private network that restricts unauthorized alteration of content delivered by a multimedia service provider. Also, as used herein, the terms “user,” “viewer,” “subscriber,” and “customer” may refer interchangeably to a person who interacts with, orders, uploads, listens to, or plays multimedia content over a subscription multimedia service.

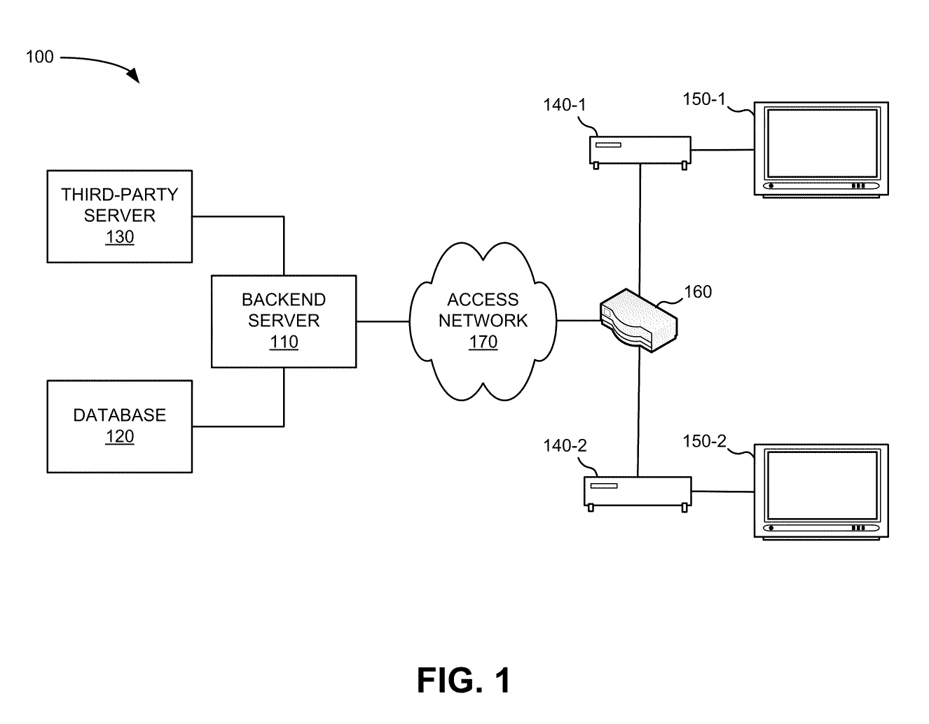

FIG. 1 is a diagram of an exemplary network 100 in which systems and/or methods described herein may be implemented. As illustrated, network 100 may include a backend server 110, a database 120, a third-party server 130, video clients 140-1 and 140-2 (herein referred to collectively as “video clients 140” and generically as “video client 140”), video display devices 150-1 and 150-2 (herein referred to collectively as “video display devices 150” and generically as “video display device 150”), a local gateway 160, and an access network 170. Video clients 140, video display devices 150 and gateway 160 may be located on a customer's premises and may be connected via access network 170 to backend server 110 at, for example, a subscription television service provider's premises. Components of network 100 may interconnect via wired and/or wireless connections. For simplicity, a single backend server 110, database 120, third-party server 130, local gateway 160, and access network 170, and two video clients 140 and two video display devices 150 have been illustrated in FIG. 1. In practice, there may be more networks, servers, databases, local gateways, video clients, and/or video display devices. Also, in some instances, one or more of the components of network 100 may perform one or more functions described as being performed by another one or more of the components of network 100.

Backend server 110 may include one or more devices for providing content/information to video client 140 and/or video display device 150 in accordance with commands that are issued from video client 140. Examples of backend server 110 may include a headend device that provides broadcast television programs and/or pay-per-view (PPV) events, a video-on-demand (VOD) device or another device that provides multimedia content upon request, an advertising server that provides advertising associated with multimedia content, and/or a program guide information server that provides information related to multimedia content available to video client 140.

In general, backend server 110 may provide control over (e.g., via access network 170) television services for devices, such as video clients 140, video display devices 150, and/or other network connectivity devices (e.g., telephones and personal computers, not shown) provided at the customer's premises. Backend server 110 may communicate with a variety of other components, such as databases, gateways, web servers, network switches or routers, television broadcast facilities, and other servers to facilitate television services to customers. Backend server 110 may also receive information from one or more video clients 140, such as user selections of transactional advertisements. Backend server 110 may serve as a link between a video client 140 and third-party server 130 to enable transactions between the third party server 130 and video client 140. For example, backend server 110 may facilitate communications with video client 140 via access network 170 and communications with third-party server 130 via an external network (e.g., the Internet). In one implementation, backend server 110 may also store information from video clients 140 and/or third-party server 130, for example, in database 120 or another memory component, for later retrieval. While shown as a single server component in FIG. 1, in other implementations, backend server 110 may be distributed among multiple servers.

Database 120 may include one or more memory devices that maintain transaction histories (such as responses and/or purchases related to transactional advertisements) of video clients. In one implementation, database 120 may include exemplary fields, such as a user-identification field, a date field, a time field, a revenue field, an advertisement field, an interactive television application field, and/or a program content identification field. While only one database is shown in FIG. 1, database 120 may include multiple databases stored locally at backend server 110 and/or stored at one or more different and possibly remote locations. Database 120 may group customers' viewing histories by individual users, user groups, interactive television application type, and/or by program. Database 120 may also maintain additional or different information relating, for example, to interactive television applications used, types of advertisements, programs watched/recorded/ordered by viewers, etc. Information from database 120 may be retrieved by backend server 110 (or another server device), for example, to monitor advertising data, such as view response rates, revenue, etc.

Third-party server 130 may include one or more server entities, or other types of computation or communication devices, that gather, process, search, and/or provide information in a manner described herein. Third-party server 130 may provide data to and conduct transactions with video client 140 and/or backend server 110. In one implementation, third-party server 130 may communicate with video client 140 via backend server 110 to conduct transactions. Third-party server 130 may also provide interactive television applications that may be provided to video client 140 (e.g., via backend server 110 and access network 170). In one implementation, third-party server 130 may communicate with backend server 110 through a hypertext transfer protocol over secure socket layer (HTTPS) on the Internet. In an exemplary implementation, third-party server 130 may be controlled by a different entity than the entity that controls backend server 110. In another exemplary implementation, third-party server 130 and backend server 110 may be controlled by the same entity (e.g., the subscription multimedia service provider).

Video client 140 may include any device capable of receiving, transmitting and/or processing information to and/or from access network 170. In one implementation, video client 140 may be a closed device (e.g., including a hardware/software configuration that is not accessible to the general public) that restricts unauthorized alteration of programming delivered over the closed distribution network. Video client 140 may provide video signals to video display device 150. Examples of video client 140 may include a set-top box, a computer, a cable card, and a portable electronic device. Video client 140 may receive a television signal from gateway 160, may convert the signal to a form usable by video display device 150, and may transmit the signal to video display device 150 for display. Video client 140 may further allow a user to provide user input for interactive television applications (e.g., to navigate menu displays or select menu items) and to alter the programming provided to video display device 150 based on a signal (e.g., a channel up or channel down signal) from, for example, a remote control (not shown). Video client 140 may also be capable of sending data to backend server 110 via access network 170. In some implementations, video client 140 may be incorporated into video display device 150, such as a television, a computer, or a portable electronic device.

In one implementation, video client 140 may display advertising information (e.g., a transactional advertisement) that may receive user input. For example, video client 140 may receive an advertisement that may be selected by a user via a remote control signal. Video client 140 may transmit information about the user's selection to a server (e.g., backend server 110 and/or third-party server 130) to initiate a transactional sequence associated with the advertisement. In another implementation, video client 140 may track information relating to a sequence of user interactions with video display device 150 and may present locally stored information to the user. Video client 140 may provide some or all of the tracked information to a server, such as backend server 110, at a later time.

Video display device 150 may include a digital or analog display via which a user may view multimedia content (including, for example, conventional programming, interactive displays, and/or advertising). Video display device 150 may refer to any device that can receive and display multimedia content delivered over access network 170 and/or through video client 140 for perception by users. Video display device 150 may include technologies, such as cathode ray tube (CRT) displays, liquid crystal displays (LCDs), light-emitting diode (LED) displays, plasma displays, etc.

Gateway 160 may include a network device that provides an interface from access network 170 to video clients 140 and/or other network connectivity devices (not shown). For example, when telecommunication services are provided to the customer's premises via an optical fiber, gateway 160 may include an optical network terminal (ONT) that connects to the optical fiber. The ONT may convert between signals appropriate for video display device 150 and signals appropriate for transmission over optical fiber. For example, the ONT may include a coaxial cable connection that leads to video display device 150 or video client 140. The ONT may also include an Ethernet output port that connects to a personal computer or a voice over Internet protocol (VoIP) telephone and/or a standard telephone port for connecting to a standard telephone.

Gateway 160 may include one of a number of possible gateway devices, including a satellite antenna and receiver, a coaxial cable connection, an ONT, or a broadband access for Internet Protocol TV (IPTV). The satellite antenna and receiver may provide an interface for television services broadcast from satellites. The coaxial cable connection may provide an interface for television services connected to a customer via coaxial cables. The ONT may provide an interface for an optical fiber connection. The broadband IPTV access may generally include any device that provides broadband access over which television service may be provided.

Access network 170 may include a video signaling and distribution network and system that permit transfer of data between backend server 110 and video clients 140. Additionally, access network 170 may include, among other things, a firewall, a filtering mechanism, a proxy, and/or network address translation mechanisms. Access network 170 may include, for example, a single network, such as a wide area network (WAN), a local area network (LAN), a metropolitan area network (MAN), a telephone network (e.g., a public switched telephone network (PSTN) or a wireless network), the Internet, a satellite network, etc., or a combination of networks. Access network 170 may provide customers with multimedia content provided, for example, by backend server 110 and/or third-party server 130. Access network may also support communications between backend server 110 and video clients 140 using, for example, Internet protocol (IP).

In implementations described herein, a user may select an interactive television application to be displayed on video display device 150. Backend server 110 may provide, to video client 140 via access network 170, a transactional advertisement to be displayed within a portion of the interactive television application or elsewhere on a display. When a user selects (e.g., via a remote control), the transactional advertisement, video client 140 may notify backend server 110 of the selection. Backend server 110 may initiate a communication session between video client 140 and third-party server 130 associated with the selected transactional advertisement. In another implementation, third-party server 130 may include a server entity controlled by the subscription multimedia service provider to facilitate secure transactions with video client 140 and another server entity controlled by another party to provide advertising content. Transactions may, thus, be conducted almost entirely within a portion of network 100 controlled by the subscription multimedia service provider and a report may be generated to for click-through payment collection by the advertising content provider.

By providing an interface that is compatible with video client 140/video display device 150, third-party server 130 may conduct a transaction with a user of video client 140. The transaction between third-party server 130 and the user of video client 140 may be monitored by backend server 110 and data regarding the transaction may be stored in database 120 for subsequent analysis.

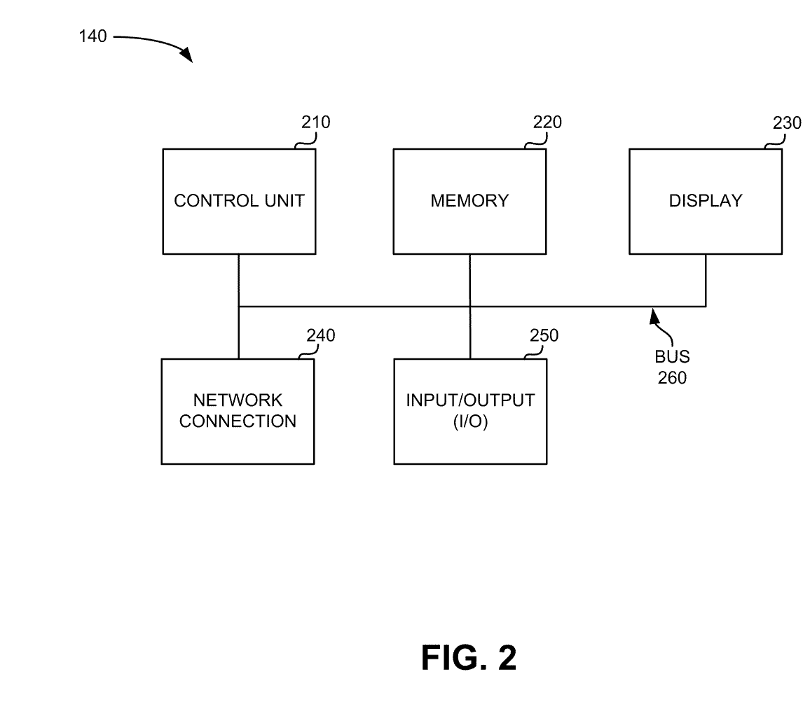

FIG. 2 is diagram illustrating exemplary components of video client 140. As shown, video client 140 may include a control unit 210, a memory 220, a display 230, a network connection 240, an input/output (I/O) component 250, and a bus 260.

Control unit 210 may include one or more processors, microprocessors, or another type of processing logic that interprets and executes instructions. Among other functions, control unit 210 may collect and store viewer activity associated with television programming. Control unit 210 may execute instructions to send viewing history information to another device, such as backend server 110. Control unit 210 may also receive information and/or instructions from other devices, such as backend server 110.

Memory 220 may include one or more dynamic or static storage devices that may store information and instructions for execution by control unit 210. For example, memory 220 may include a storage component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. In one implementation, memory 220 may store a viewer activity log to send at a later point in time, such as when requested by backend server 110.

Display 230 may include any component capable of providing visual information. For example, in one implementation, display 230 may be a light emitting diode (LED) or a liquid crystal display (LCD). In another implementation, display 230 may use another display technology, such as a dot matrix display, etc. Display 230 may display, for example, text (such as a time, a date or a channel selection), image, and/or video information. Display 230 may be an optional component.

Network connection 240 may include any transceiver-like mechanism that enables video client 140 to communicate with other devices and/or systems, such as backend server 110. For example, network connection 240 may include an Ethernet interface, an optical interface, a coaxial interface, a radio interface, or the like. Network connection 240 may allow for wired and/or wireless communication. Network connection 240 may be configured to connect video client 140 to a packet-based IP network.

Input/output devices 250 may generally include user input devices such as external buttons, and output devices, such as LED indicators. With input/output devices 250, a user may generally interact with video client 140. In some implementations, input/output devices 250 may be implemented via a remote control. Bus 260 may provide an interface through which components of video client 140 can communicate with one another.

As will be described in detail below, video client 140 may perform certain operations relating to displaying information and communicating viewer activities to a server, such as backend server 110. Video client 140 may perform these operations in response to control unit 210 executing software instructions contained in a computer-readable medium, such as memory 220. A computer-readable medium may be defined as a physical or logical memory device. A logical memory device may refer to memory space within a single, physical memory device or spread across multiple, physical memory devices. The software instructions may be read into memory 220 from another computer-readable medium or from another device. The software instructions contained in memory 220 may cause control unit 210 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 illustrates exemplary components of video client 140, in other implementations, video client 140 may include fewer, different, differently arranged, or additional components than those depicted in FIG. 2. In still other implementations, one or more components of video client 140 may perform one or more other tasks described as being performed by one or more other components of video client 140.

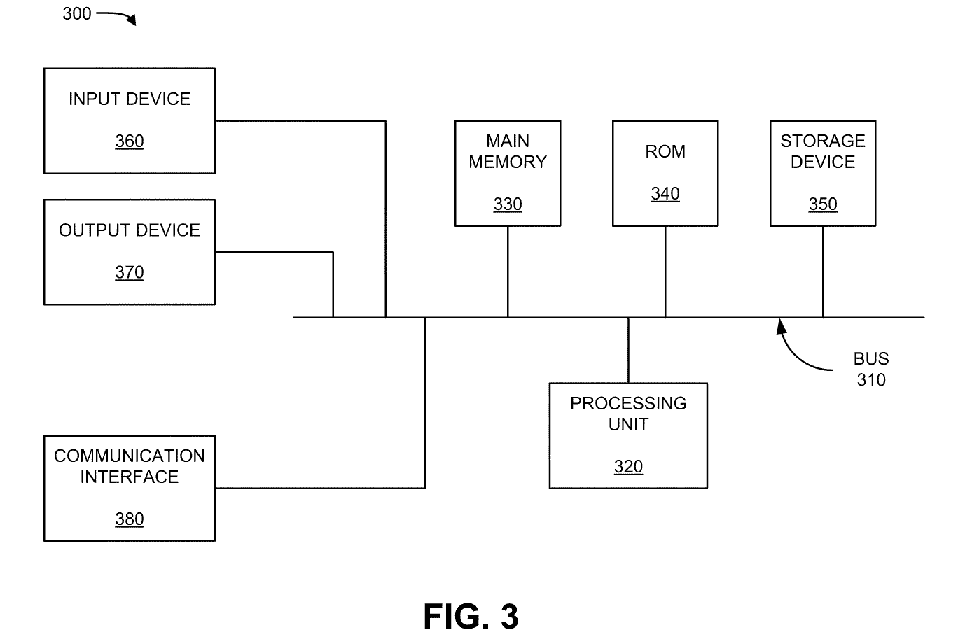

FIG. 3 is a diagram of exemplary components of a device 300 that may correspond to backend server 110 and/or third-party server 130. As illustrated, device 300 may include a bus 310, a processing unit 320, a main memory 330, a read-only memory (ROM) 340, a storage device 350, an input device 360, an output device 370, and a communication interface 380.

Bus 310 may include a path that permits communication among the components of device 300. Processing unit 320 may include one or more processors, microprocessors, or other types of processing units, such as application-specific integrated circuits (ASICs), field-programmable gate arrays (FPGAs), etc., that may interpret and execute instructions.

Main memory 330 may include a RAM or another type of dynamic storage device that stores information and instructions for execution by processing unit 320. ROM 340 may include a ROM device or another type of static storage device that may store static information and instructions for use by processing unit 320. Storage device 350 may include a magnetic and/or optical recording medium and its corresponding drive. In one implementation, storage device may include database 120 or another database. Storage device 350 may store viewer transaction history for particular video clients 140 or all video clients 140 associated with a subscription multimedia service provider.

Input device 360 may include a mechanism that permits an operator to input information to device 300, such as a keyboard, a mouse, a pen, voice recognition and/or biometric mechanisms, a touch-screen interface, etc. Output device 370 may include a mechanism that outputs information to the operator, including a display, a printer, a speaker, etc. Communication interface 380 may include any transceiver-like mechanism that enables device 300 to communicate with other devices and/or systems, such as video client 140.

As will be described in detail below, device 300 may perform certain operations associated with providing transactional advertising for a subscription television service. Device 300 may perform these and other operations in response to processing unit 320 executing software instructions contained in a computer-readable medium, such as main memory 330. The software instructions may be read into main memory 330 from another computer-readable medium, such as storage device 350, or from another device via communication interface 380. The software instructions contained in main memory 330 may cause processing unit 320 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

Although FIG. 3 illustrates exemplary components of device 300, in other implementations, device 300 may include fewer, different, differently arranged, or additional components than those depicted in FIG. 3. In still other implementations, one or more components of device 300 may perform one or more other tasks described as being performed by one or more other components of device 300.

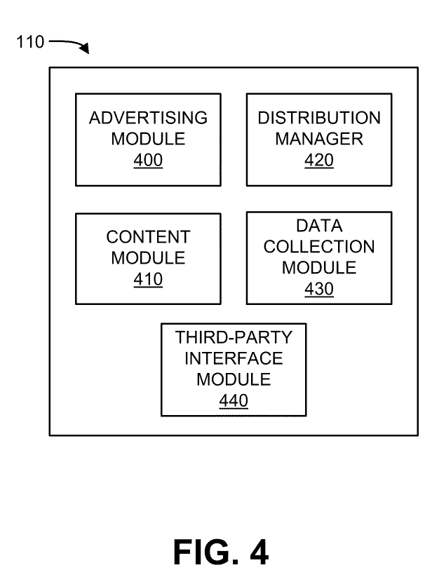

FIG. 4 is an exemplary diagram of functional components of backend server 110. The functional components of backend server 110 may be implemented by, for example, one or more of the components of device (FIG. 3). Backend server 110 may include an advertising module 400, a content module 410, a distribution module 420, a data collection module 430, and third-party interface module 440.

Advertising module 400 may include hardware or a combination of hardware and software that that provides advertising content and/or links to advertising content that may be retrieved by distribution manager 410 and/or video client 140. Advertising module 400 may include advertising in multiple formats, such as video (analog and/or digital), images, text, etc. Advertising content may include advertising for third-party products and/or advertising from the subscription multimedia provider (e.g., for premium channels, VOD, PPV offers, etc.). In one implementation, advertising may be transactional advertising configured to be integrated into a designated visible location within an interactive television application and/or configured to be displayed simultaneously with a multimedia program (e.g., in a dedicated advertising space adjacent to a television program display).

Content module 410 may include hardware or a combination of hardware and software that provides multimedia content such as video, audio, interactive applications, and/or images that may be requested by/provided to video client 140. Content module 410 may include, for example, broadcast television programs, PPV programming, games, interactive television applications, images, files, and/or other media that may be made available to customers of a subscription multimedia service provider.

Distribution manager 420 may include hardware or a combination of hardware and software that matches advertising content from advertising module 400 with content from content module 410. For example, advertisements may be cross-referenced to particular keywords, demographics, interests, or other indicators associated with content from content module 410. In one implementation, distribution manager 420 may associate appropriate advertising with user-selected content and direct the adverting to video client 140 or display to the user.

Data collection module 430 may include hardware or a combination of hardware and software for retrieving user data from one or more video clients (e.g., video client 140) or servers (e.g., third-party server 130). In one implementation, video client 140 may track information relating to transactional advertising and provide the information to data collection module 430. In other implementations, data collection module 430 may monitor information sent from video client 140 and/or third-party server 130 to obtain transactional advertising information. Transactional advertising information may include, for example, what advertisement was selected, time of day, related application and/or programming information, whether a purchase was made, categories of purchases, etc.

Third-party interface module 440 may include hardware or a combination of hardware and software for facilitating communications between a video client 140 (e.g., that uses access network 170) and a third-party server 130 (e.g., that uses a secure IP connection). Third-party interface module 440 may receive a notification from a video client 140 that a user has selected a transactional advertisement. Third-party interface module 440 may identify the video client 140 and the appropriate third-party server 130 to enable secure communications between video client 140 and third-party server 130. Third-party interface module 440 may also receive content/updates for interactive television applications being used by video client 140 and new interactive television applications submitted from third-party server 130 for use by video clients 140.

Although FIG. 4 illustrates exemplary functional components of backend server 110, in other implementations, backend server 110 may include fewer, different, differently arranged, or additional functional components than those depicted in FIG. 4. In still other implementations, one or more functional components of backend server 110 may perform one or more other tasks described as being performed by one or more other functional components of backend server 110.

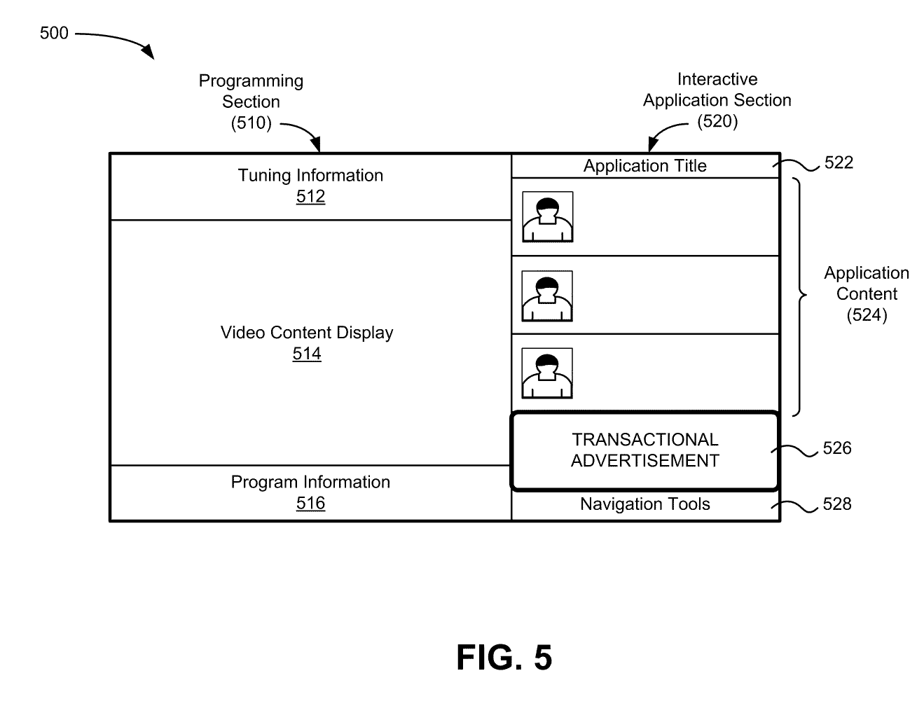

FIG. 5 provides a diagram of an exemplary on-screen display 500 that includes a transactional advertisement according to an implementation described herein. On screen display 500 may be configured by, for example, video client 140 and/or backend server 110 and presented on video display device 150.

As shown in FIG. 5, on-screen display may include a programming section 510 and an interactive application section 520. Programming section 510 may include tuning information 512, a video content display 514, and program information 516. Interactive application section 520 may include an application title section 522, an application content section 524, a transactional advertisement section 526, and navigation tools 528. Although FIG. 5 illustrates an exemplary arrangement of on-screen display 500, in other implementations, on-screen display 500 may include fewer, different, differently arranged, or additional sections than those depicted in FIG. 5.

Programming section 510 may generally include video content and related information for general television viewing. Tuning information 512 may include, for example, a channel number, network name, and/or program name for a particular program selected by a user (e.g., via a remote control or other input to video client 140). Video content display 514 may include the actual programming selected by the user, such as a broadcast television program, PPV content, streaming video, or other video content. Program information 516 may include, for example, information relating to the program selected by the user, such as a program description, time-slot, episode name, etc.

Interactive application section 520 may generally include presentation of an application that may be selected by a user for inclusion in on-screen display 500. For example, interactive application section 520 may include display of an interactive television application that provides content (e.g., posts from other users, images etc.) related to programming section 510. Application title section 522 may include, for example, a name, logo, or other image associated with the application being presented in interactive application section 520. Application content 524 may include content for the application selected by the user, such as social networking postings, local information, links/invitations to other information, etc.

Transactional advertisement section 526 may include an advertisement that may contain a link or instruction that may be acted upon by a user (e.g., via a remote control). For example, transactional advertisement section 526 may include advertising content related to programming section 510 and/or interactive application section 520. While transactional advertisement section 526 is shown in FIG. 5 within interactive application section, in other implementations transactional advertisement section 526 may be included in other locations within display 500, including, for example, overlaid over all or a portion of programming section 510 and/or interactive application section 520. Transactional advertisement section 526 may also include a mechanism for a user to interact with the displayed advertising. For example, using a remote control, a user may navigate through sections of interactive application section 520 to highlight transactional advertisement section 526, such that pressing a particular button on the remote control (e.g., “enter” or “OK”) may indicate to video client 140 a selection by the user. In another implementation, the content within transactional advertisement section 526 may include instructions for how a user may indicate a selection via the remote control (e.g., “Press ‘C’ to order”). User interactions using a remote control may be supported using, for example, Enhanced TV Binary Interchange Format (EBIF) or other remote control interfaces.

As described further herein, video client 140 may receive the user input to transactional advertisement section 526 and provide a subsequent display in response to the user input. The subsequent display may include, for example, a transaction screen to enable a user to conduct a transaction (e.g., a purchase of the advertised product). In another implementation, the subsequent display may include an intermediate transaction screen to present a user with the option to connect to a third-party server. In one implementation, video client 140 may notify backend server 110 of the user input and receive instructions for the subsequent display. In another implementation, video client 140 may retrieve stored information (e.g., from memory 220) that may be responsive to the user input.

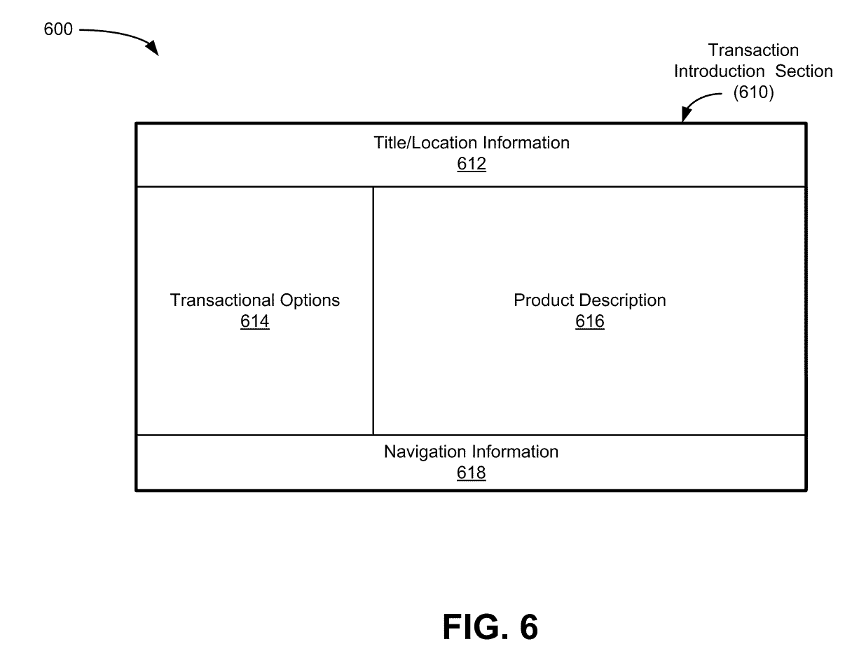

FIG. 6 illustrates a diagram of an exemplary on-screen display format including a transaction screen 600 according to an implementation described herein. Transaction screen 600 may include a transaction introduction section 610. Although FIG. 6 illustrates an exemplary arrangement of transaction screen 600, in other implementations, transaction screen 600 may include fewer, different, differently arranged, or additional sections than those depicted in FIG. 6. For example, transaction introduction section 610 may be presented in the entirety of transaction screen 600, as shown in FIG. 6, or in conjunction with one or more other sections, such as programming section 510 and/or interactive application section 520.

Transaction introduction section 610 may be used to present any of a wide variety of product types, including tangible products (e.g., physical media and other products) and access rights to digital media (e.g., PPV event orders, ringtones, applications, etc.). Transaction introduction section 610 may include a title/location information section 612, a transactional options section 614, a product description section 616, and a navigation information section 618. Title/location information section 612 may include information regarding the type of information presented in section 610 and/or an indication of a directory or other guidance for the user. Transactional options section 614 may include options available for a user to continue with the transaction process. For example, transactional options section 614 may include options to proceed with a purchase, to obtain more information about the advertised product, to see related products, or the like. Product description section 616 may include information about the product advertised in transactional advertisement section 526. For example, product description section 616 may include images, video clips, and/or text to describe the advertised product and/or information related to the product (e.g., price, availability, etc.). Navigation information section 618 may include options the user may select to navigate through other viewing options. For example, navigation information section 618 may include options to return to previously viewed screens, to switch to other viewing options, to present other applications, etc.

In one implementation, sections of transaction introduction section 610 may be combined. For example, transactional options section 614 and product description section 616 may be combined as a video/audio component that describes a product and provides instructions for user interactions (e.g., via remote control) to proceed.

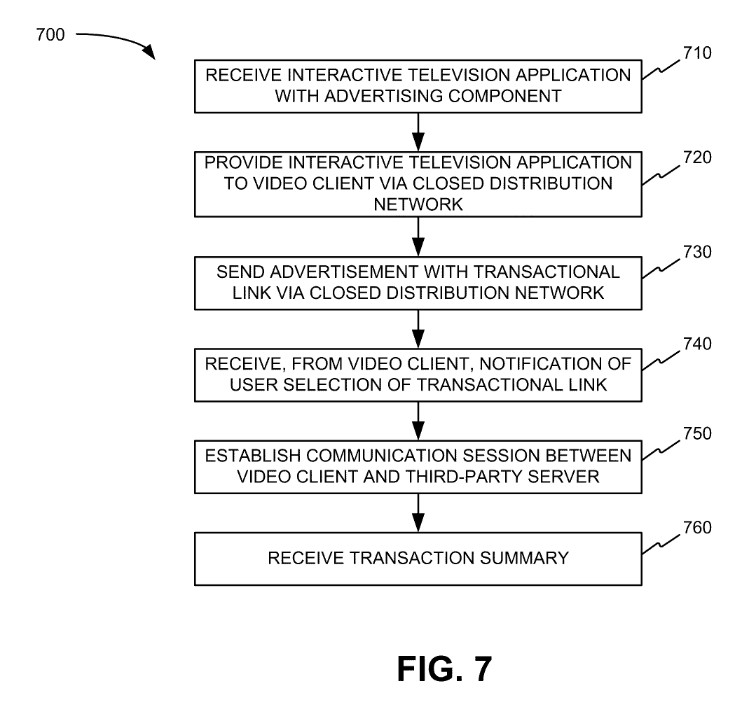

FIG. 7 provides a flow chart of an exemplary process 700 for offering transactional advertising in a closed distribution network. Some or all of process 700 may be performed by one or more servers associated with a subscription television service, such as backend server 110. In some implementations, some or all of process 700 may also be performed by one or more video clients 140 and/or third-party servers 130.

Process 700 may include receiving an interactive television application with an advertising component (block 710). For example, backend server 110 may receive an interactive television application with a dedicated advertising section (e.g., transactional advertisement section 526) from third-party server 130. In one implementation, the interactive television application may be provided over a secure network connection, using, for example, IP. The interactive television application may be configured to allow video client 140 and/or backend server 110 to insert one or more transactional advertisements for presentation to a user when the interactive television application is being displayed.

The interactive television application may be provided to a video client via a closed distribution network (block 720). For example, backend server 110 may provide the transactional advertising application to video client 140 using access network 170. In another implementation, the interactive television application may be included with video client 140 as original equipment manufacture (OEM) equipment.

An advertisement containing a transactional link may be sent via the closed distribution network (block 730). For example, backend server 110 may provide a transactional advertisement to video client 140 via access network 170. Video client 140 may insert the transactional advertisement into a visible portion of video display device 150 (e.g., transactional advertisement section 526) for presentation to and possible selection by a user.

A notification of a user's selection of the transactional link may be received from the video client (block 740). For example, backend server 110 may receive a signal from video client 140 indicating a user has selected the transactional link in the transactional advertisement provided. The notification may include an identification of the video client, an identification of the relevant third-party server, and/or other information sufficient for backend server 110 to initiate a communication session between video client 140 and third-party server 130.

A communication session may be established between the video client and the third-party server (block 750). For example, backend server 110 may act as a gateway to establish a secure connection between video client 140 and third-party server 130 associated with the transactional link. The communication session may permit a user of video client 140 to conduct a transaction (e.g., to purchase an advertised product) with third-party server 130. In some implementations, the communication session may include authorization information (e.g., user password, etc.), establishing/verifying user account information for the user, providing financial/payment information, and/or providing shipping information.

A transaction summary may be received (block 760). For example, backend server 110 may receive a transaction summary of the transaction conducted between video client 140 and third-party server 130. In one implementation, the transaction summary may be provided to backend server 110 by third-party server 130. In another implementation, the transaction may be provided to backend server 110 by video client 140 and/or a combination of third-party server 130 and video client 140. In one implementation, the transaction summary may be stored in a memory (e.g., database 120) associated with backend server 110.

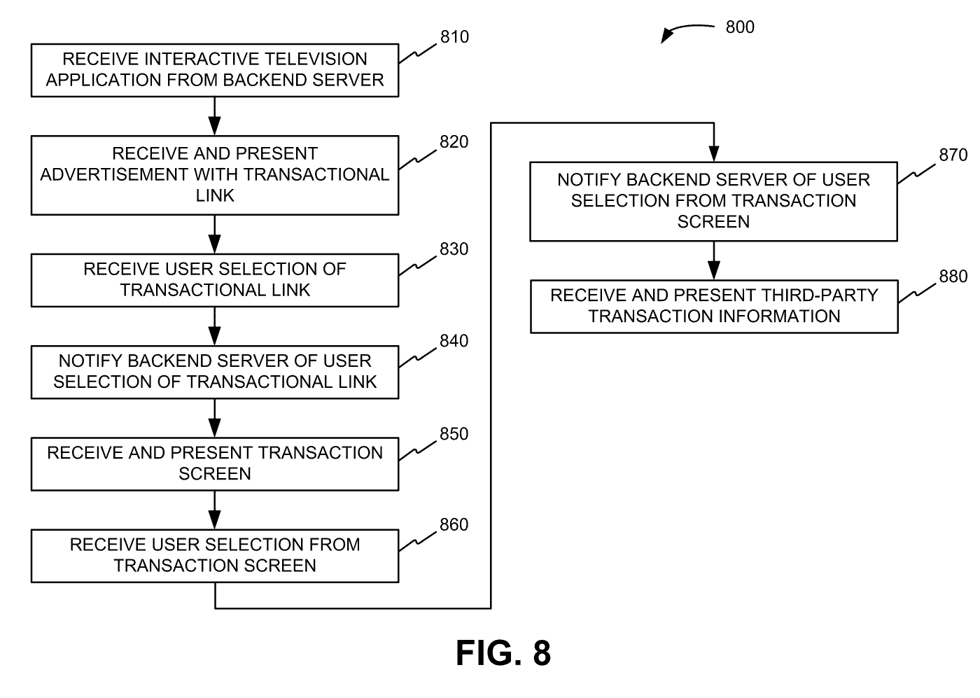

FIG. 8 provides a flow chart of an exemplary process 800 for offering transactional advertising in a closed distribution network. Some or all of process 800 may be performed by a video client associated with a subscription television service, such as video client 140. In some implementations, some or all of process 800 may be performed by video client 140 in conjunction with a backend server 110 and/or a third-party server 130.

Process 800 may include receiving an interactive television application from a backend server (block 810). For example, video client 140 may receive from backend server 110 an interactive television application. The interactive television application may be, for example, a software application provided to backend server 110 from third-party server 130 that is configured to work within an operating platform of the subscription television service and/or video client 140.

An advertisement with a transactional link may be received and presented (block 820). For example, video client 140 may receive an advertisement from backend server 110 that includes a link to allow for user input. The advertisement may be integrated into a template, for example, to display to a viewer via video display device 150. In one implementation, the advertisement may be integrated into an interactive application section (e.g., interactive application section 520) of an on-screen display. In other implementations, a dedicated section or window overlay may be used to present the advertisement to the user.

A user selection of the transactional link may be received (block 830). For example, video client 140 may receive a user's selection of a transactional link within transactional advertisement section 526. The user's selection may be initiated via a remote control, keyboard, or other device that allows for user input to video client 140. For example, a user may navigate through sections of interactive application section 520 to identify and select transactional advertisement section 526. In another implementation, a user may follow instructions within the content of the transactional advertisement section 526 to indicate a selection (e.g., “Press ‘C’ to order”).

The backend server may be notified of the user selection of the transactional link (block 840). For example, video client 140 may notify backend server 110, via access network 170, that a user has selected the transactional link of transactional advertisement section 526. The notification may include, for example, an identifier of video client 140 (e.g., a unique identification number) and an indication of the selected advertisement and/or transactional link (e.g., an IP address or other unique identifier).

A transaction screen may be received and presented (block 850). For example, video client 140 may receive instructions for presenting transaction screen 600 on video display device 150. The instructions may be received from backend server 110 directly or from third-party server 130 via backend server 110. The transaction screen may provide additional information about the advertised product and/or other related products. In another implementation, the transaction screen may be retrieved from a local memory (e.g., memory 220) associated with video client 140.

A user selection from the transaction screen may be received (block 860). For example, video client 140 may receive a user's selection for a transactional link from transactional options section 614 of transaction screen 600. The user's selection may be initiated via a remote control, keyboard, or other device that allows for user input to video client 140. For example, a user may navigate through sections of transaction screen 600 to identify and select an option from transactional options section 614. In another implementation, a user may follow instructions within the displayed content of transactional options section 614 to indicate a selection (e.g., “Press ‘B’ to see trailer”, “Press ‘C’ to buy now,” etc.).

The backend server may be notified of the user selection from the transaction screen (block 870). For example, video client 140 may notify backend server 110, via access network 170, that a user has selected a particular option from transactional options section 614 of transaction screen 600. The notification from video client 140 may include, for example, an indication of the video client associated with the request along with an indication of what was requested by the user. Based on the notification from video client 140, backend server 110 may establish a communication session between video client 140 and third-party server 130 to allow a user of video client 140 to conduct a transaction with third-party server 130.

Third-party transaction information may be received and presented (block 880). For example, video client 140 may receive, via backend server 110 and access network 170, information to complete a transaction for the advertised product. In one implementation, the information may be integrated into a template, for example, to display to a viewer via video display device 150.

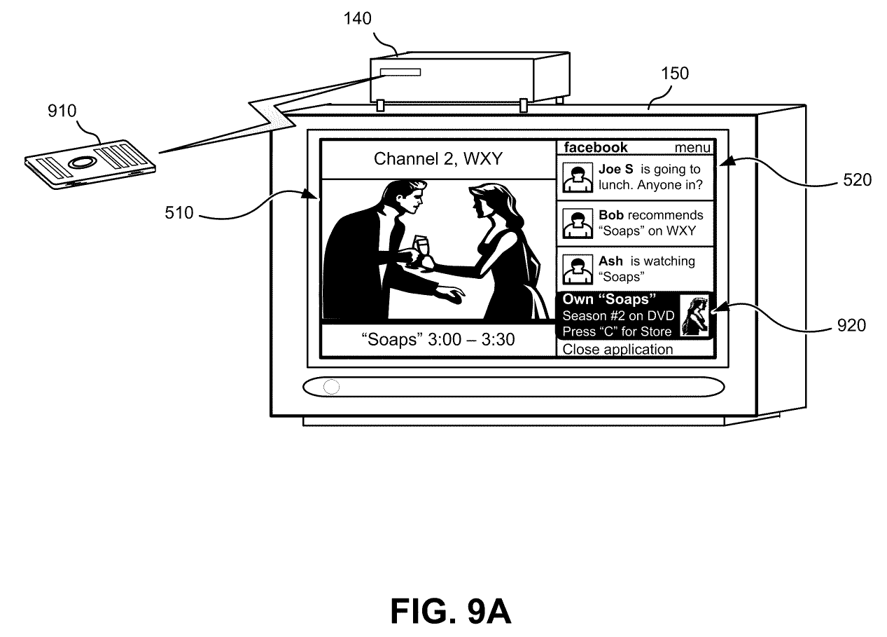

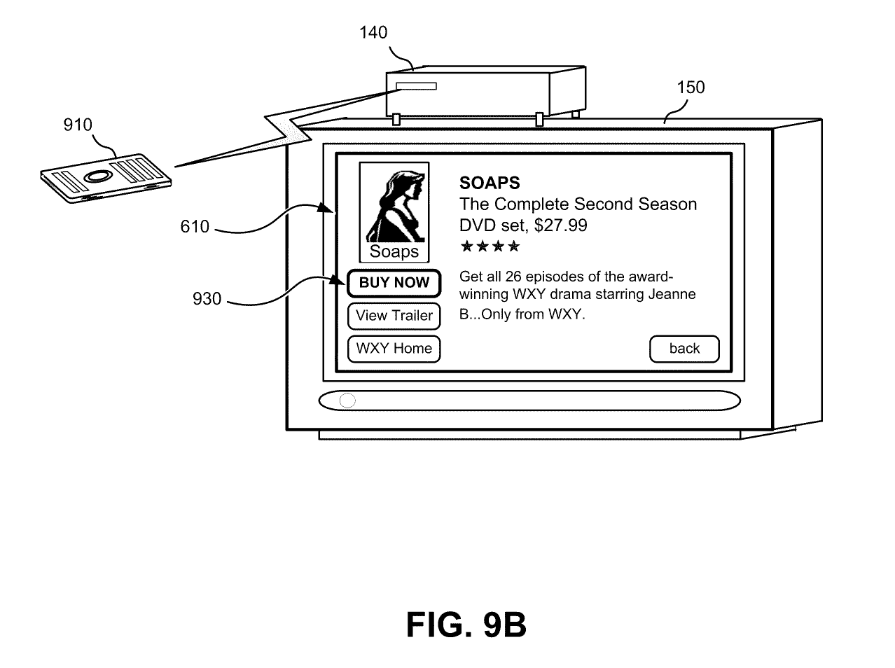

FIGS. 9A and 9B provide exemplary diagrams illustrating implementations of a customer interface for transactional advertisements in a closed distribution network according to implementations described herein. More specifically, FIG. 9A provides an exemplary diagram of an on-screen display that includes a transactional advertisement, and FIG. 9B provides an exemplary diagram of a transaction screen for a selected transactional advertisement.

Referring to FIG. 9A, a viewer may view a display on video display device 150 that includes a programming section 510 and an interactive application section 520. The display on video display device 150 may be controlled by video client 140 as directed by user commands from a remote control 910. In the example of FIG. 9A, interactive application section 520 may include an advertisement 920 that includes a transactional link. The viewer may select (e.g., via remote control 910) the link from advertisement 920.

In one implementation, selecting the link from advertisement 920 may cause video client 140 to present transaction screen 610, as shown in FIG. 9B. Transaction screen 610 may include additional details for the product advertised in advertisement 920. Video client 140 may retrieve information for transaction screen 610 from internal memory (e.g., memory 220), from backend server 110, and/or from third-party server 130 (e.g., via backend server 110). The viewer may select (e.g., via remote control 910) a link 930 to initiate a purchase process for the advertised product. Selection of link 930 may cause video client 140 to notify a backend server (e.g., backend server 110) of the user's selection. Based on information in the notification, the backend server may establish a communication session between video client 140 and a third-party server (e.g., third-party server 130) associated with the advertisement.

The illustrations of FIGS. 9A and 9B are exemplary formats for presenting transactional advertisements in a closed distribution network. Other formats and variations may be used.

Implementations described herein may provide systems and/or methods that provide transactional advertisements within a subscription multimedia network. The systems and/or methods may include sending, over the subscription multimedia network, an advertisement for presentation by a video client, where the advertisement includes a transactional link and receiving, over the subscription multimedia network, a notification from the video client that a user has selected the transactional link. The systems and/or methods may also include automatically establishing, based on the notification, a communication session between the video client and a server associated with the advertisement, where the communication session may enable a transactional exchange between a user of the video client and the server associated with the advertisement.

The foregoing description provides illustration and description, but is not intended to be exhaustive or to limit the implementations to the precise form disclosed. Modifications and variations are possible in light of the above teachings or may be acquired from practice of systems and/or methods disclosed herein.

For example, while series of blocks have been described with regard to the flowcharts of FIGS. 7 and 8, the order of the blocks may differ in other implementations. Further, non-dependent blocks may be performed in parallel.

It will be apparent that exemplary aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by one or more devices within a closed distribution network, comprising:
sending, by one of the one or more devices and over the closed distribution network, an advertisement for presentation by a video client, where the advertisement includes a transactional link;
receiving, by one of the one or more devices and over the closed distribution network, a notification from the video client that a user has selected the transactional link; and
automatically establishing, by one of the one or more devices and based on the notification, a communication session between the video client and a server associated with the advertisement, where the communication session enables a transactional exchange between a user of the video client and the server associated with the advertisement.

2. The method of claim 1, further comprising:
providing an interactive television application to the video client via the closed distribution network, where the interactive television application includes a presentation format to display the advertisement.

3. The method of claim 1, where automatically establishing the communication session between the video client and the server associated with the advertisement comprises:
establishing a communication session between the video client and the server associated with the advertisement using a communication channel other than the closed distribution network.

4. The method of claim 1, further comprising:
receiving, from one of the video client or the server, a transaction summary of the communication session.

5. The method of claim 4, further comprising:
storing the transaction summary of the communication session in a memory associated with one of the one or more devices.

6. The method of claim 1, where the server associated with the advertisement is external to the closed distribution network.

7. The method of claim 1, where the server associated with the advertisement is internal to the closed distribution network.

8. The method of claim 1, where the notification includes:
an identifier for the video client, and
an identifier for the server associated with the advertisement.

9. A system, comprising:
a memory to store instructions; and
a processor to execute the instructions to:
send, to a video client via a closed distribution network, an advertisement for presentation to a user, where the advertisement includes a transactional link selectable by a user,
receive, from the video client via the closed distribution network, a notification that the user has selected the transactional link, and
initiate, based on the notification, a communication session between the video client and a server that is associated with the advertisement.

10. The system of claim 9, where the communication session enables a transactional exchange between the user of the video client and the server associated with the advertisement.

11. The system of claim 9, where the processor is further to execute instructions to:
receive an interactive television application, where the interactive television application includes instructions to display the advertisement, and
provide the interactive television application to the video client via the closed distribution network.

12. The system of claim 9, where the communication session between the video client and the server includes an Internet protocol (IP) session.

13. The system of claim 9, where the processor is further to execute instructions to:
receive, from one of the video client or the server external to the closed distribution network, a transaction summary of the communication session.

14. A method implemented by a video client, comprising:
receiving, by the video client and via a closed distribution network, an advertisement that includes a transactional link;
presenting, on a display, the advertisement to a user;
receiving, by the video client, a user selection of the transactional link;
sending, by the video client and over the closed distribution network, a notification of the user selection to a backend server;
receiving, by the video client and over the closed distribution network, transactional information from a server associated with the transactional link; and
sending, by the video client and over the closed distribution network, transactional information to the server associated with the transactional link.

15. The method of claim 14, further comprising:
receiving an interactive television application from the backend server, where the interactive television application includes instructions for presenting a transactional advertisement.

16. The method of claim 14, where the user selection is provided via a remote control.

17. The method of claim 14, where the advertisement includes instructions to a user for selecting the transactional link.

18. The method of claim 14, further comprising:
sending, to the backend server, at least part of the transactional information sent to the server associated with the transactional link.

19. A system, comprising:
one or more devices within a closed distribution network, the one or more devices comprising:
means for receiving, from a backend server, an advertisement that includes a transactional link;
means for presenting the advertisement to a user;
means for receiving a user selection of the transactional link;
means for sending a notification of the user selection to the backend server;
means for receiving transactional information from a server associated with the advertisement, where the server associated with the transactional link is external to the closed distribution network; and
means for sending transactional information to the server associated with the advertisement.

20. The system of claim 19, further comprising:
means for receiving an interactive application that includes instructions for presenting the advertisement that includes the transactional link.

21. The system of claim 19, further comprising:
means for sending, to the backend server, at least part of the transactional information sent to the server associated with the transactional link.
